(19) United States
(12) Patent Application Publication
(10) Pub. No.: US 2026/0073607 A1
(43) Pub. Date: Mar. 12, 2026

(54) PHYSICS-BASED SKELETAL MOTION GENERATION BY VIDEO DIFFUSION DISTILLATION

(71) Applicant: NVIDIA Corporation, Santa Clara, CA (US)

(72) Inventors: Xuan Li, Los Angeles, CA (US); Donglai Xiang, San Jose, CA (US); Qianli Ma, Zürich (CH); Tsung-Yi Lin, Sunnyvale, CA (US); Ming-Yu Liu, Redwood City, CA (US); Yongxin Chen, Suwanee, GA (US)

(21) Appl. No.: 19/094,230

(22) Filed: Mar. 28, 2025

Related U.S. Application Data
(60) Provisional application No. 63/692,356, filed on Sep. 9, 2024.
(60) Provisional application No. 63/720,597, filed on Nov. 14, 2024.

(51) Int. Cl. G06T 13/40

(52) U.S. Cl. CPC G06T 13/40

(57) ABSTRACT

Apparatuses, systems, and techniques for synthesizing motion for three-dimensional (3D) assets. In at least one embodiment, a static 3D asset is obtained based on textual input. The static 3D asset is represented by a 3D spatial representation and an articulated skeleton embedded in the 3D spatial representation. The motion of the articulated skeleton is linked to the deformation of the 3D spatial representation. A sequence of skeleton configurations are generated based on the articulated skeleton, corresponding to a plurality of time steps. A corresponding 3D spatial representation configuration is generated for each skeleton configuration. Based on the sequence of 3D spatial representation configurations, a sequence of image frames are generated to provide a video. A video model evaluates the difference between the video and the textual input to provide a video evaluation loss, which is backpropagated to update the sequence of skeleton configurations.

### CLAIM OF PRIORITY

This application claims the benefit of U.S. Provisional Application No. 63/692,356 titled “Physics-Based Skeletal Motion Generation By Video Diffusion Distillation,” filed Sep. 9, 2024, and U.S. Provisional Application No. 63/720,597 titled “Physics-Based Skeletal Motion Generation By Video Diffusion Distillation,” filed Nov. 14, 2024, the entire contents of which are incorporated herein by reference.

### BACKGROUND

Conventional video models face common issues on physical plausibility, such as generating multiple heads or incorrect numbers of limbs for characters. Traditional computer graphics, on the other hand, begins with three-dimensional (3D) representations, applying deformations and rendering techniques to create two-dimensional (2D) videos. This strict adherence to 3D modeling prevents the arbitrary appearance of extra heads or limbs and ensures the physical plausibility of articulated motion following natural anatomy during video sequences. Text-to-4D generation follows a similar approach, typically using an existing text-to-3D tool to create a static 3D model, which video models then animate to introduce motion and dynamics into the asset.

However, these frameworks commonly rely on deformation fields, which predict displacements at each location to deform 3D assets. While flexible, this approach introduces a high number of degrees of freedom (DoFs), making optimization challenging and often resulting in suboptimal quality.

In traditional 3D animation, a more efficient technique for deforming 3D assets is through rigging systems, where the kinematics of embedded articulated skeletons controls 3D characters. Skeleton-based rigging significantly reduces DoFs and produces movements that better align with characters' articulated structures. However, using rigging systems still requires detailed manual work by artists and precise observation of real-world motions to achieve realism. In contrast, large video models possess internet scale knowledge of diverse motions, offering a promising resource to enhance motion realism and reduce the need for extensive manual labor.

### SUMMARY

Embodiments of the present disclosure relate to physics-based skeletal motion generation by video diffusion distillation. Systems and methods are disclosed that utilize a framework to synthesize motion by combining the strengths of skeleton-based animation and modern generative models. The framework uses a skeleton-based representation to model the motion of three-dimensional (3D) assets and evaluates a motion video of the 3D assets, derived from skeletal motion, in the context of textual input describing the motion of the 3D assets. This method allows for motion modeling in a low-dimensional space while leveraging prior knowledge from video diffusion models to evaluate the motion synthesis. Additionally, the framework utilizes physics-based simulation to refine the synthesized motion. Experimental results demonstrate that the framework outperforms existing text-to-4D generation methods in both 3D consistency and expressive motion quality.

### BRIEF DESCRIPTION OF THE DRAWINGS

The present systems and methods for physics-based skeletal motion generation by video diffusion distillation are described in detail below with reference to the attached drawing figures, wherein:

FIG. 1A is a flow diagram illustrating a method for generating animation, in accordance with some embodiments;

FIG. 1B provides examples of animations generated from textual inputs, in accordance with some embodiments;

FIG. 1C provides examples of 3D static assets embedded with a rigging system, in accordance with some embodiments;

FIG. 1D provides additional examples of 3D static assets embedded with a rigging system, in accordance with some embodiments;

FIG. 2A is a flowchart illustrating a method for generating a synthesized motion, in accordance with some embodiments;

FIG. 2B illustrates a pipeline for generating a synthesized motion, in accordance with some embodiments;

FIG. 3A is a flowchart illustrating a method for generating a simulated motion, in accordance with some embodiments;

FIG. 3B provides examples of the synthesized motion and the corresponding simulated motion, in accordance with some embodiments;

FIG. 3C provides examples of artifacts, in accordance with some embodiments;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to physics-based skeletal motion generation by video diffusion distillation, and in particular, to a text-driven generative framework for animating static three-dimensional (3D) assets, providing physics-grounded motion corresponding to a textual input. In at least one embodiment, the text-driven, generative framework is referred to as Articulated Motion Distillation (AMD). In one or more embodiments, the text-driven generative framework includes an asset generation stage, a motion synthesis stage, and a physics-grounded simulation stage.

In one or more embodiments, the asset generation stage generates a static 3D asset based on an input prompt. The static 3D asset may be generated based on one or more types of input, including, e.g., textual input, audio input, visual input, or other types of input. In at least one embodiment, the textual input describes an asset and its motion. For example, the textual input may specify actions such as “the asset is walking,” “the asset is running,” or “the asset is jumping.” In at least one embodiment, the 3D assets to be animated can include various types of digital entities, such as human figures, animals, fantasy creatures, avatars, robots, inanimate objects, and environmental elements, or any other suitable characters or assets. The static 3D asset includes one or more 3D representations and a rigging system with a reduced dimension provided and linked to the one or more 3D representations. In certain embodiments, the one or more 3D representations include one or more of a mesh, a 3D Gaussian Splatting (3DGS) representation, and/or another type of 3D representation. In certain embodiments, the rigging system is an articulated skeleton modeled as a series of movable joints and rigid bones.

In one or more embodiments, the motion synthesis stage utilizes a differentiable pipeline to link a motion of the rigging system to a synthesized video of the 3D asset. A generative video model is leveraged to generate a video of the 3D asset, e.g., in the context of the textual input. Through multiple iterations, synthesized motion of the 3D asset can be generated and optimized to align with the synthesized video. A loss gradient is backpropagated from the pixel space (of the video) through a differentiable pipeline and ultimately to the rigging system, enabling updates to optimizable parameters of the rigging system. This approach enables the framework to drive motion synthesis for a 3D asset by utilizing a low-dimensional parameter space (associated with the rigging system) and generating the motion in the low-dimensional parameter space by utilizing video diffusion priors that have learned general visual knowledge. At the physics-grounded simulation stage, a physics-based model is utilized to refine the synthesized video from the differentiable pipeline.

In at least one embodiment, the asset generation stage (i) includes: (a) generating, via a text-to-3D generator and/or an image-to-3D generator, a 3D mesh corresponding to the asset, (b) providing a dual mesh-3D Gaussian Splatting (3DGS) representation of the asset, and (c) rigging the asset with an embedded articulated skeleton. The embedded articulated skeleton includes a set of bones and a set of joints that connect bones. In certain embodiments, a Forward Kinematics (FK) model is utilized to evaluate deformations of bones. For example, the FK model takes joint angles as input and produces bone positions as output. In certain embodiments, an interpolation scheme, such as linear blend skinning (LBS), can be utilized to provide a deformation function, defined on the entire 3D space, for mapping bone deformations to mesh vertex and/or Gaussian kernel deformations. In this manner, a mapping is established between the motion of the embedded articulated skeleton and the motion of the mesh and/or 3DGS representation of the asset.

In at least one embodiment, the motion synthesis stage (ii) includes: (a) rendering an image (e.g., a “frame”) corresponding to the 3DGS representation of the asset for each of a plurality of time steps to provide a video; (b) providing the video, along with textual input, to a diffusion transformer (DiT) and obtaining, from the DiT, a score distillation sampling (SDS) loss (which measures a difference between the video and the textual input); (c) computing and backpropagating gradients of the SDS loss (1) from the pixel space corresponding to the frames of the video, (2) via a differentiable Gaussian Splatting rasterizer, to the 3DGS representation of the asset, and (3) via the LBS interpolation scheme, to the embedded articulated skeleton; and (c) updating, based on the backpropagated gradient, optimizable variables of the embedded articulated skeleton. In at least one embodiment, the optimizable variables include, for each frame of the video, a 3D angle vector for each joint and a 6-DoF rigid transformation of the root bone. Following the updating of the optimizable variables of the embedded articulated skeleton, the process is repeated. For example, a new video is rendered, a new SDS loss is computed, a new gradient is backpropagated, and the optimizable variables are again updated.

In at least one embodiment, the physics-grounded simulation stage (iii) includes: (a) providing a sequence of target skeleton configurations (produced by the motion synthesis stage), which include target joint configurations and bone coordinates at each of a plurality of time steps; (b) using a joint control sequence and a physics-grounded state transition function to simulate motion of a skeleton under gravity and ground collision, thereby providing simulated joint configurations and bone coordinates at each of the plurality of time steps; (c) computing a motion tracking loss, which measures the difference—at each time step—between the simulated coordinates and the target coordinates; (d) computing and backpropagating the gradient of the motion tracking loss with respect to parameters of the joint control sequence; and (e) updating the parameters of the joint control sequence based on the computed gradient. Following the updating of the parameters of the joint control sequence, the process is repeated. For example, a new simulated motion is generated, a new motion tracking loss is computed, a new gradient is computed and backpropagated, and the parameters of the joint control sequence are again updated.

In at least one embodiment, a rigging system provided by an articulated skeleton is embedded in a static 3D asset (e.g., a mesh and/or 3DGS representation), and a set of optimizable parameters (e.g., low-dimensional joint angles and rigid bone transformations) that represent configurations of the skeleton are learned so as to synthesize skeletal motion. A differentiable pipeline links the optimizable parameters of the articulated embedded skeleton to a video that is provided as input to a video model. The video model evaluates the input video in the context of the textual input and provides an SDS loss. A gradient of the SDS loss is backpropagated to the set of optimizable parameters of the articulated embedded skeleton. This approach enables the framework to drive motion synthesis for a 3D asset by utilizing a low-dimensional parameter space (associated with the skeleton) and generating skeletal motion by utilizing video diffusion priors that have learned general visual knowledge.

By linking a skeleton-based representation to the deformation of the 3D asset, the framework harnesses the strengths of skeleton-based animation, modeling motion with significantly reduced Degrees of Freedom (DoFs). The framework generates input videos based on the deformation of the 3D asset, using video diffusion models to evaluate the synthesized motion, leveraging prior knowledge from these models. This method effectively distills complex, articulated motions while preserving structural integrity, addressing challenges faced by four-dimensional (4D) neural deformation fields in maintaining shape consistency. Additionally, the framework's output is compatible with physics-based simulations, allowing for refinement of the motion to ensure physically plausible interactions. Compared to prior art techniques for motion synthesis, the combination of linking a skeleton-based representation to the deformation of the 3D representation of the 3D asset, utilizing video diffusion models to evaluate motion synthesis, and incorporating physics-grounded simulation to refine the motion provides notably enhanced and more realistic videos of 3D assets.

A method is provided for motion synthesis, which includes: obtaining a static three-dimensional (3D) asset comprising a 3D spatial representation and an articulated skeleton embedded in the 3D spatial representation, and generating, based on the articulated skeleton, a sequence of skeleton configurations. In at least one embodiment, each skeleton configuration corresponds to a time step of a plurality of time steps. The method further includes: generating, for each skeleton configuration in the sequence of skeleton configurations, a corresponding 3D spatial representation configuration, generating, based on the sequence of 3D spatial representation configurations, a sequence of image frames to provide a video, obtaining, based on the video and a textual input describing a motion of the 3D asset, a video evaluation loss, updating, based on the video evaluation loss, the sequence of skeleton configurations, and outputting, based on the updated sequence of skeleton configurations, an updated video of motion of the 3D asset.

According to an embodiment of the method, the method further includes: obtaining a target sequence of skeleton configurations, obtaining an initial simulated skeleton configuration and a joint control sequence that provides physics-grounded skeletal motion, learning a simulated joint control sequence by updating parameters of the joint control sequence by iteratively reducing a difference between the target sequence of skeleton configurations and a sequence of simulated skeleton configurations, outputting a final sequence of simulated skeleton configurations corresponding to the learned simulated joint control sequence, and outputting, based on the final sequence of simulated skeleton configurations, a final video of simulated motion of the 3D asset.

According to an embodiment of the method, learning the simulated joint control sequence is performed using a physics-grounded simulation incorporating gravity and ground collision.

According to an embodiment of the method, the method further includes: computing a video loss gradient based on the video evaluation loss, and backpropagating the video loss gradient to the sequence of skeleton configurations.

According to an embodiment of the method, the video loss gradient is computed in a latent space. In at least one embodiment, the video loss gradient passes through a pixel space, a space corresponding to the 3D spatial representation, and a space corresponding to the articulated skeleton. In at least one embodiment, the video loss gradient is used to update the sequence of skeleton configurations in the space corresponding to the articulated skeleton.

According to an embodiment of the method, the articulated skeleton comprises a set of bones and a set of joints that connect the set of bones. In at least one embodiment, motion of the articulated skeleton is modeled through a set of joint angles and bone transformations corresponding to the set of bones and the set of joints.

According to an embodiment of the method, the bone transformations are obtained using Forward Kinematics based on the set of joint angles.

According to an embodiment of the method, the video loss gradient is used to update the set of joint angles and the bone transformations to update the sequence of skeleton configurations in the space corresponding to the articulated skeleton.

According to an embodiment of the method, the video is rendered with at least one of: a non-uniform ground, shadow casting, or a varying camera trajectory.

According to an embodiment of the method, the static 3D asset is obtained based on the textual input.

A machine-readable medium is provided having stored thereon a set of instructions, which if performed by one or more processors, cause the one or more processors to perform the method for motion synthesis.

A system is provided for motion synthesis, which includes one or more processors configured to: obtain a static three-dimensional (3D) asset comprising a 3D spatial representation and an articulated skeleton embedded in the 3D spatial representation, and generate, based on the articulated skeleton, a sequence of skeleton configurations. In at least one embodiment, each skeleton configuration corresponds to a time step of a plurality of time steps. The one or more processors are further configured to: generate, for each skeleton configuration in the sequence of skeleton configurations, a corresponding 3D spatial representation configuration, generate, based on the sequence of 3D spatial representation configurations, a sequence of image frames to provide a video, obtain, based on the video and a textual input describing a motion of the 3D asset, a video evaluation loss, update, based on the video evaluation loss, the sequence of skeleton configurations, and output, based on the updated sequence of skeleton configurations, an updated video of motion of the 3D asset.

According to an embodiment of the system, the one or more processors are further configured to: obtain a target sequence of skeleton configurations, obtain an initial simulated skeleton configuration and a joint control sequence that provides physics-grounded skeletal motion, learn a simulated joint control sequence by updating parameters of the joint control sequence by iteratively reducing a difference between the target sequence of skeleton configurations and a sequence of simulated skeleton configurations, output a final sequence of simulated skeleton configurations corresponding to the learned simulated joint control sequence, and output, based on the final sequence of simulated skeleton configurations, a final video of simulated motion of the 3D asset.

According to an embodiment of the system, learning the simulated joint control sequence is performed using a physics-grounded simulation incorporating gravity and ground collision.

According to an embodiment of the system, the one or more processors are further configured to: compute a video loss gradient based on the video evaluation loss, and backpropagate the video loss gradient to the sequence of skeleton configurations.

According to an embodiment of the system, the video loss gradient is computed in a latent space. In at least one embodiment, the video loss gradient passes through a pixel space, a space corresponding to the 3D spatial representation, and a space corresponding to the articulated skeleton. In at least one embodiment, the video loss gradient is used to update the sequence of skeleton configurations in the space corresponding to the articulated skeleton.

According to an embodiment of the system, the articulated skeleton comprises a set of bones and a set of joints that connect the set of bones. In at least one embodiment, motion of the articulated skeleton is modeled through a set of joint angles and bone transformations corresponding to the set of bones and the set of joints.

According to an embodiment of the system, the bone transformations are obtained using Forward Kinematics based on the set of joint angles.

According to an embodiment of the system, the video loss gradient is used to update the set of joint angles and the bone transformations to update the sequence of skeleton configurations in the space corresponding to the articulated skeleton.

According to an embodiment of the system, the video is rendered with at least one of: a non-uniform ground, shadow casting, or a varying camera trajectory.

According to an embodiment of the system, the static 3D asset is obtained based on the textual input.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

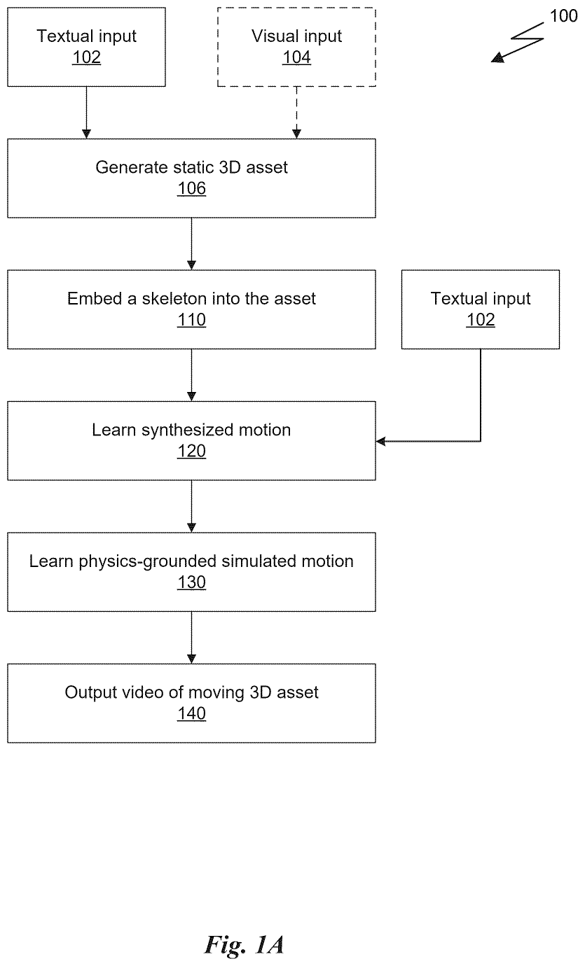

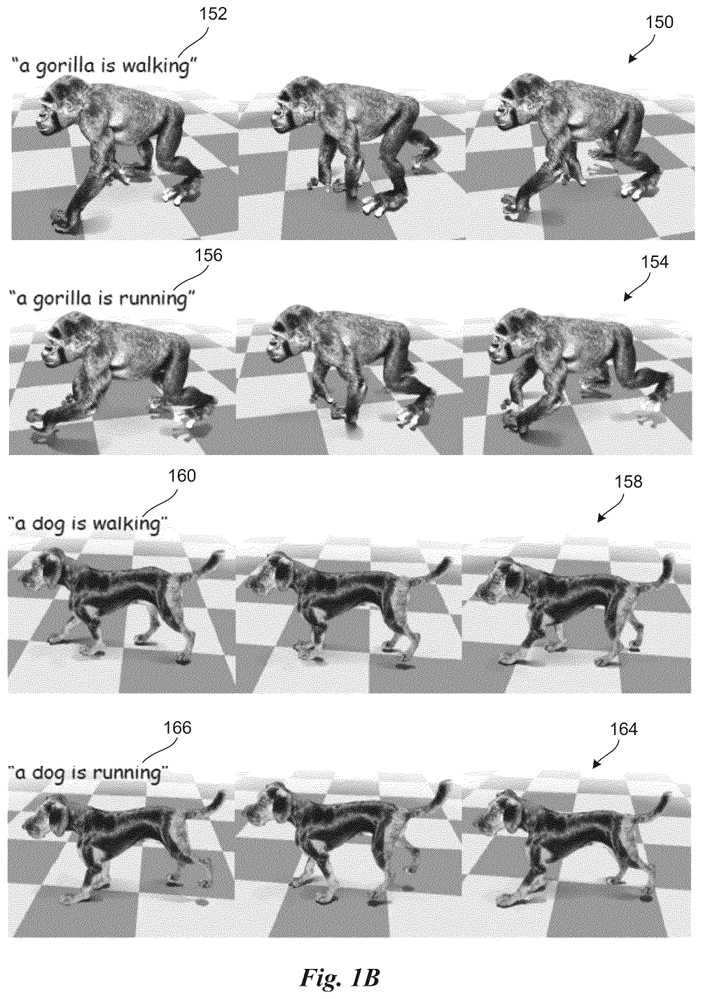

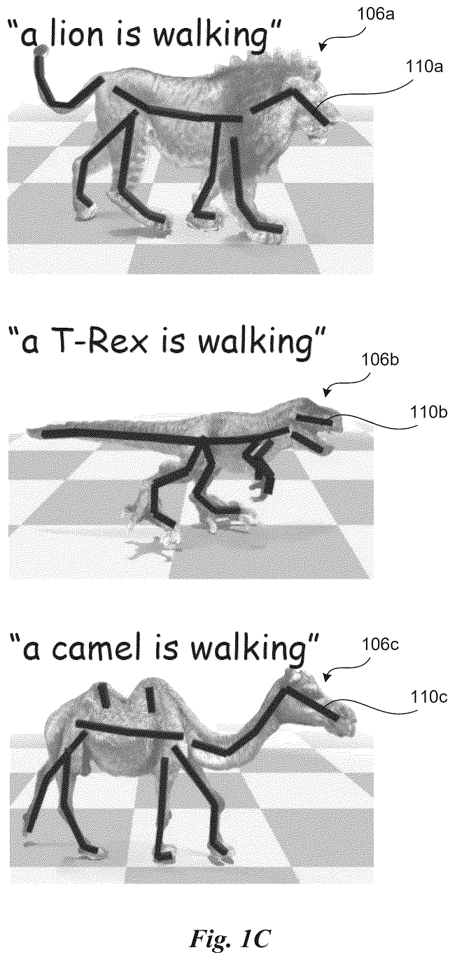

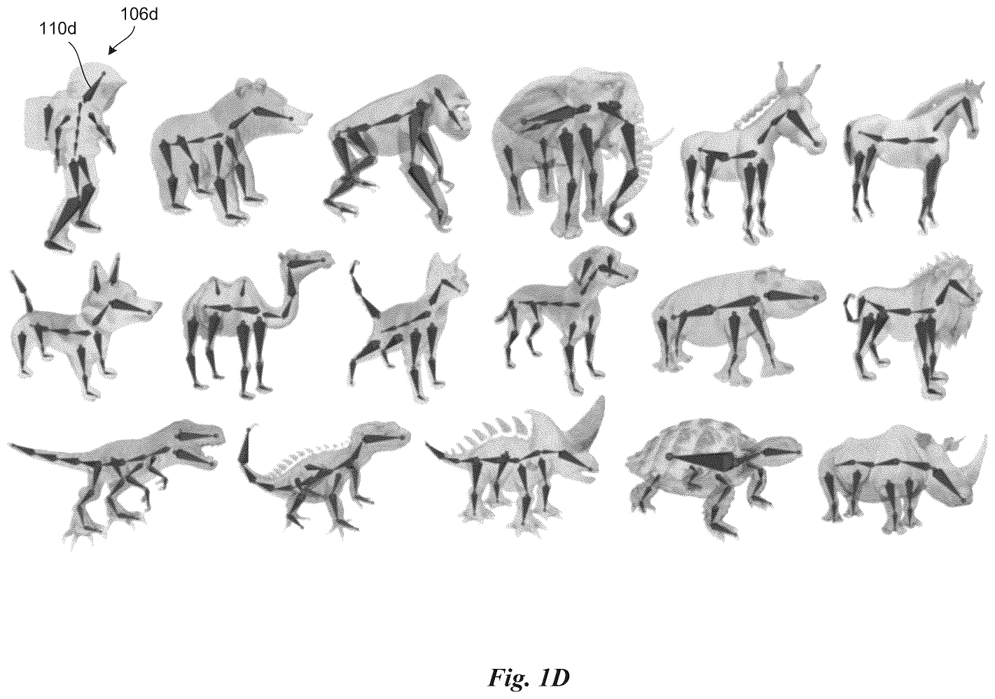

FIG. 1A is a flow diagram illustrating a method 100 for generating animation, in accordance with some embodiments. Each block of method 100, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 100 is described, by way of example, with respect to a text-driven generative framework. However, this method may additionally or alternatively be executed by any one framework/system, or any combination of frameworks/systems, including, but not limited to, those described herein. Furthermore, persons of ordinary skill in the art will understand that any framework/system that performs method 100 is within the scope and spirit of embodiments of the present disclosure.

In certain embodiments, the text-driven generative framework is configured to generate an animation of a 3D asset based on textual input. For example, the textual input (e.g., textual input 102) describes an asset and its motion. An asset refers to a type of digital entity, such as human figures, animals, fantasy creatures, avatars, robots, inanimate objects, and environmental elements, or any other suitable characters or assets. In at least one embodiment, the textual input may specify actions such as “the asset is walking,” “the asset is running,” “the asset is jumping,” among other suitable movements.

FIG. 1B provides examples of animations generated from textual inputs, in accordance with some embodiments. For example, a video 150 is generated based on textual input 152, which states: “a gorilla is walking.” A video 154 is generated based on textual input 156, which states: “a gorilla is running.” A motion video 158 is generated based on textual input 160, which states: “a dog is walking.” Furthermore, a motion video 162 is generated based on textual input 164, which states: “a dog is running.”

In certain embodiments, the text-driven generative framework receives other types of input to describe the asset and/or its motion, such as audio input, visual input (e.g., visual input 104), or other suitable sources. When other types of input data are utilized for generating the 3D asset, a textual description aligned with the other types of input data may be generated or provided for later processing, such as serving as the textual input 102 to be used at stage 120.

In certain embodiments, the text-driven generative framework performs stages 102/104, and 106 of the method 100 during the asset generation stage.

At stage 106, method 100 obtains textual input 102 (and, optionally, visual input 104) to generate the static 3D asset. For example, with textual input, the framework can utilize a text-to-3D generator to generate the static 3D asset at 106. Additionally and/or alternatively, with image input, the framework can utilize an image-to-3D generator to generate the static 3D asset. However, it should be noted that the framework may include other suitable functional modules to process various types of input data to generate the static 3D asset. The text-to-3D and/or the image-to-3D generator may be an off-the-shelf generator or a customized one. Furthermore, it should be noted that assets derived from photogrammetry or created by artists should work in a similar manner.

In certain embodiments, the framework obtains one or more representations for the static 3D asset. For example, the static 3D asset may be converted to a mesh representation and/or a 3DGS representation. A mesh representation in graphics refers to the use of polygons, typically triangles or quadrilaterals, to represent the surface of a 3D object. The mesh includes vertices, edges, and faces that define the shape and geometry of the object in 3D space. A 3DGS representation refers to the use of 3D Gaussian kernels to represent a 3D scene. The 3DGS rendering typically involves the use of data structures and algorithms to represent, manipulate, and display the 3D scene (and one or more 3D objects therein), incorporating various elements such as textures, lighting, and camera positions.

At stage 110, the framework rigs the asset with an embedded articulated skeleton. The embedded articulated skeleton includes a set of bones and a set of joints that connect bones. The motion of the articulated skeleton can be modeled through a set of joint angles and bone transformations corresponding to the set of bones and the set of joints.

FIG. 1C provides examples of 3D static assets embedded with a rigging system, in accordance with some embodiments. For example, a 3D asset 106a can be generated based on the text: “a lion is walking.” An articulated skeleton 110a is embedded into the asset 110a. Similarly, a 3D asset 106b with an embedded articulated skeleton 110b can be generated based on the text: “a T-Rex is walking,” and a 3D asset 106c with an embedded articulated skeleton 110c can be generated based on the text: “a camel is walking.”

FIG. 1D provide additional examples of 3D static assets embedded with a rigging system, in accordance with some embodiments. For example, a 3D astronaut 106d is embedded with an articulated skeleton 110d. As shown in this example, the articulated skeleton 110a may be used to simulate any potential moving parts of the asset, for example, including the body of the astronaut and the equipment worn by the astronaut.

Furthermore, at this stage, a mapping is established between the motion of the embedded articulated skeleton and the motion of the mesh and/or 3DGS representation of the asset. For example, a deformation function is utilized to map bone deformations to mesh vertex and/or Gaussian kernel deformations.

In certain embodiments, each Gaussian kernel is defined by a set of parameters: σₚ, xₚ, Σₚ, and [symbol] ₚ, where σₚ denotes opacity, xₚ and Σₚ represent the center and covariance matrix of the Gaussian ellipsoid, respectively, and [symbol] ₚ is the coefficient set of spherical harmonics that determines the view-dependent colors of the kernel. The 3DGS representation, such as the set of Gaussian kernels, can be rendered to produce color images. In certain embodiments, given a camera view, the color of a pixel (C) is rendered by α-blending all kernels along the ray direction:

$$C = {\sum }_{i} {c}_{i} {α}_{i} {\prod }_{j = 1}^{i - 1} ( 1 - {α}_{j} ) , \qquad ( Eq . 1 )$$

where i is the sorted index of the kernels in ascending order of z-depth, cᵢ represents the kernel's color under the given camera view, evaluated from spherical harmonics, and αᵢ is the opacity σᵢ weighted by the kernel's 3D Gaussian distribution. Given a set of images with known camera parameters, the 3D scene can be reconstructed using only RGB loss.

In certain embodiments, given a warping function φ: [symbol] ³→ [symbol] ³, for example, provided by suitable methods such as PhysGaussian, the shape of each Gaussian kernel can be deformed using the local linearization of φ at its center: xₚ: φ(x)≈φ(xₚ)+∇φ(xₚ)(x−xₚ), resulting in:

$${\tilde{x}}_{p} = ϕ ( {x}_{p} ) , {\tilde{\sum }}_{p} = ∇ ϕ ( {x}_{p} ) {\sum }_{p} ∇ {ϕ ( {x}_{p} )}^{T} , \qquad ( Eq . 2 )$$

where (xₚ, Σₚ) and (\tilde{x}ₚ, \tilde{Σ}ₚ) denote the Gaussian parameters before and after the deformation, respectively. In certain embodiments, for simplicity, the opacifies and spherical harmonics can be held constant.

In certain embodiments, the deformation function is provided based on an interpolation scheme, such as Linear Blending Skinning (LBS), which can be formulated as follows:

$$ϕ ( x ) = {\sum }_{i = 1}^{B} {w}_{i} ( {R}_{i} x + {T}_{i} ) , \qquad ( Eq . 3 )$$

where B is the number of bones, (Rᵢ, Tᵢ) is the rigid transformation of bone i, and wᵢ is a skinning weight, satisfying Σᵢwᵢ=1. The deformation field, as expressed by Equation 3, is defined on the 3D space. In certain embodiments, the deformation field is applied to mesh vertices. Additionally and/or alternatively, the deformation field can be applied to deform Gaussian kernels as formulated by Equations 2, where

$$∇ ϕ ( x ) = {\sum }_{i = 1}^{B} {w}_{i} {R}_{i} .$$

In certain embodiments, the skinning weights to the Gaussian kernels are transferred by barycentric interpolation of skinning weights at their nearest points on the template mesh.

At stage 120, the framework learns a synthesized motion aligned with the textual input 102. In certain embodiments, the framework utilizes a differentiable pipeline that links the optimizable parameters corresponding to a sequence of skeleton configurations to a video containing a sequence of 2D frames in pixel space. In certain embodiments, the video is fed into a video model, which evaluates the video in the context of the textual input to obtain an SDS loss. The framework backpropagates the gradient of the SDS loss through the video model and the differentiable pipeline to the set of optimizable parameters for driving the motion of the articulated skeleton. This approach enables the framework to drive motion synthesis for a 3D asset by utilizing a low-dimensional parameter space (associated with the articulated skeleton) and generating skeletal motion by utilizing video diffusion priors that have learned general visual knowledge.

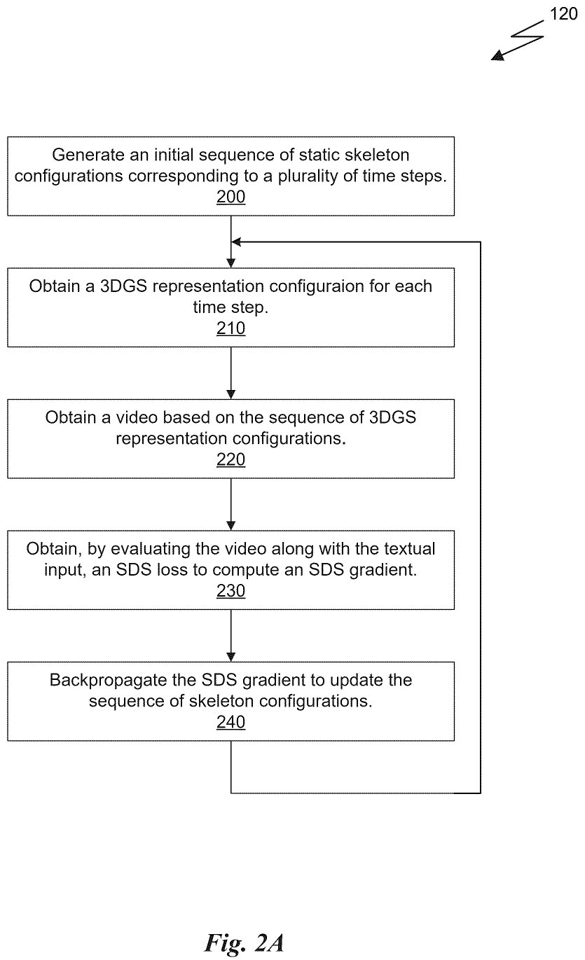

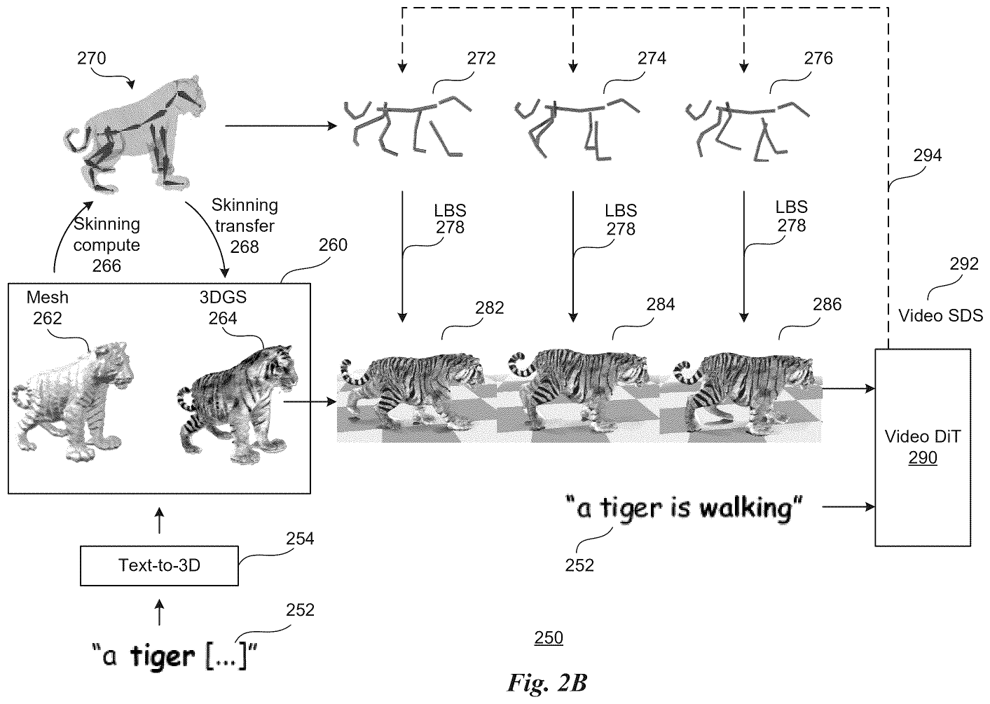

FIG. 2A is a flowchart illustrating a method for generating a synthesized motion by executing stage 120 of the method 100, as shown in FIG. 1A, in accordance with some embodiments. Each block of the method, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, the method is described, by way of example, with respect to the test-driven generative framework. However, this method may additionally or alternatively be executed by any one framework/system, or any combination of frameworks/systems, including, but not limited to, those described herein. Furthermore, persons of ordinary skill in the art will understand that any framework/system that performs the method is within the scope and spirit of embodiments of the present disclosure.

As shown in FIG. 2A, at stage 200, the framework initiates the motion synthesis by generating an initial sequence of static skeleton configurations, each corresponding to a specific time step in a plurality of time steps. In certain embodiments, the initial sequence of static skeleton configurations correspond to a static motion of the skeleton.

At stage 210, the framework obtains a 3DGS representation configuration corresponding to each skeleton configuration in the sequence of skeleton configurations. For example, Equations 2 and 3 can be applied to generate a 3DGS representation configuration for a skeleton configuration at each time step.

At stage 220, the framework obtains a video based on the sequence of 3DGS representation configurations. A video is formed based on a sequence of 2D image frames. The sequence of 2D image frames are generated based on the sequence of 3DGS representation configurations, using suitable rendering techniques. For example, a differentiable Gaussian Splatting rasterizer can be utilized to render each 3DGS representation configuration into an image at each time step. The rendered image frames are concatenated sequentially to form the video (which is also referred to as a video tensor).

In certain embodiments, when rendering the images to form the video, ground rendering is applied. In at least one embodiment, a checkerboard ground is incorporated into the image frames. This setup can provide the distillation with clues about the interaction between assets and the ground. It helps reduce relative motions between contacting parts and the ground, and helps keep assets grounded.

In certain embodiments, the checkerboard ground is rendered as a background layer by ray casting and blended with the rendering of the asset. For each ray corresponding to a pixel, the color is determined by the intersection point between the ray and the ground. If there is no intersection, the color is set to a pre-assigned value. In certain embodiments, the opacities of kernels located below the ground are set to zero to account for occlusion.

In certain embodiments, shadows are cast on the ground layer (e.g., the checkerboard ground) to further indicate the spatial relationship between the object and the ground. In at least one embodiment, when a rendering ray intersects with the ground at a point P, the ground color is weighted by the heuristic shadow intensity: s(P)=1−sₘₐₓexp(−βd(P)), where d(P) is the vertical height from the ray-ground intersection point P to the deformed asset, sₘₐₓ is the maximum level of shadowing to apply, and β is the decay coefficient as the object height above increases. This shadowing approximates a distant, parallel light source positioned vertically above the ground, complemented by diffusive ambient lighting. Incorporating shadows can enhance immersion when humans evaluate the generated videos.

In certain embodiments, the rendered video incorporates a camera trajectory. For example, the image frames in the video are object-centric, with objects (e.g., deformed objects) identified by bounding boxes. The camera can be configured to smoothly follow the bounding box center of the object in each frame. This approach is mathematically equivalent to translating the entire scene in the opposite direction while keeping the camera view fixed.

At stage 230, the framework obtains, by evaluating the video along with the textual input 102, an SDS loss to compute a gradient of the SDS loss. For example, the framework utilizes a video model to measure a difference between the input video and the textual input, thereby generating the SDS loss.

At stage 240, the framework backpropagates the SDS gradient to update the sequence of skeleton configurations.

In certain embodiments, the video model is a video diffusion model. The video diffusion model generates a diffusion loss, expressed as:

$${ℒ}_{Diff} ( θ , 𝓏 , ) = {𝔼}_{t , ϵ} [ w ( t ) {‖ \hat{ϵ} - ϵ ‖}_{2}^{2} ] , \qquad ( Eq . 4 )$$

where t˜ [symbol] (0,1) is the diffusion time step, ε˜ [symbol] (0, 1) is a Gaussian noise, zₜ=\sqrt{αₜ}z+\sqrt{1−αₜ}ε is the noisy image at step t, z is the rendered image, [symbol] is the input text, and \hat{ε}=ε_{θ}(zₜ; t, [symbol] ) is the noise predicted by the diffusion model. Without gradient propagation through the noise estimation network in the video diffusion model, an approximated gradient of the diffusion loss ( [symbol] ) with respect to the image frames can be expressed as:

$${∇}_{𝓏} {ℒ}_{SDS} ( 𝓏 , ) = {𝔼}_{t , ϵ} [ w ( t ) ( \hat{ϵ} - ϵ ) ] . \qquad ( Eq . 5 )$$

The gradient ∇_{z} [symbol] _{SDS}(z, [symbol] ) from Equation 5 is a pixel-level gradient. The pixel-level gradient is backpropagated to the 3D representation configurations (e.g., the 3DGS representation configurations) via a differentiable renderer (e.g., a differentiable Gaussian Splatting rasterizer). Furthermore, the gradient represented in the 3DGS space is backpropagated to the parameter space of the skeleton configurations through the differentiable pipeline, thereby updating the optimizable variables in the skeleton configurations, which drive the motion generation. This process guides the generation of 3D representation configurations (e.g., the 3DGS representation configurations) that are consistent with the input text.

In certain embodiments, the video diffusion model is a diffusion transformer (DiT). The DiT can be trained with a v-prediction formulation, which provides a diffusion loss defined as:

$${L}_{Diff} ( θ , 𝓏 , ) = {𝔼}_{t , ϵ} [ w ( t ) {‖ \hat{𝓏} - 𝓏 ‖}_{2}^{2} ] , \qquad ( Eq . 6 )$$

where \hat{z}=\sqrt{αₜ}zₜ+ν_{θ}(zₜ; t, [symbol] ) is the reconstruction based on the predicted velocity (ν_{θ}) by the diffusion model. Without gradient propagation through the noise estimation network in the video diffusion model, the SDS gradient is evaluated as:

$${∇}_{𝓏} {ℒ}_{SDS} ( 𝓏 , ) = {𝔼}_{t , ϵ} [ w ( t ) ( \hat{𝓏} - 𝓏 ) ] . \qquad ( Eq . 7 )$$

In certain embodiments, video diffusion models are trained in latent space by encoding raw videos using Variational Autoencoders (VAE). Correspondingly, the SDS gradient is computed on the latent codes, and then backpropagated through the VAE encoder into the pixel space. This process can be extremely memory-intensive according to one or more embodiments, especially when handling a large number of frames. In certain embodiments, suitable gradient checkpointing techniques are incorporated to reduce the memory footprint. These techniques may save memory by selectively storing intermediate activations and recomputing them during the backward pass, making it feasible to perform SDS optimization with large DiTs.

In certain embodiments, the optimizable variables in the skeleton configurations include three degrees of freedom (3-DoF) compound spherical joints to connect the bones, where each DoF represents the rotation angles around one of three linearly independent axes. The optimizable variables for each asset are expressed as:

$$Θ = {\{ {\{ {i}_{j}^{} \}}_{j = 1}^{B - 1} , \}}_{i = 0}^{F - 1} ,$$

where F is the number of frames, [symbol] is the 3D angle vector for joint j at frame i, and [symbol] denotes the 6-DoF rigid transformation of the root bone in the articulation tree (of the skeleton) at frame i. The gradient is backpropagated to the skeletal space to update the optimizable variables, such as Θ=

$${\{ {\{ {i}_{j}^{} \}}_{j = 1}^{B - 1} , \}}_{i = 0}^{F - 1} .$$

The framework repeats stages 210-240 to optimize the synthesized motion iteratively.

FIG. 2B illustrates a pipeline 250 for generating a synthesized motion, in accordance with some embodiments. Each element of pipeline 250, described herein, comprises a computing process that may be performed using any combination of hardware, firmware, and/or software. For instance, various functions may be carried out by a processor executing instructions stored in memory. The pipeline 250 may also be embodied as computer-usable instructions stored on computer storage media. The pipeline 250 may be provided by a standalone application, a service or hosted service (standalone or in combination with another hosted service), or a plug-in to another product, to name a few. In addition, the pipeline 250 is described, by way of example, with respect to the test-driven generative framework. However, this pipeline 250 may additionally or alternatively be executed by any one framework/system, or any combination of frameworks/systems, including, but not limited to, those described herein. Furthermore, persons of ordinary skill in the art will understand that any framework/system that performs the pipeline is within the scope and spirit of embodiments of the present disclosure. The pipeline 250 demonstrates example processes performed at stages 102, 106, 110, and 120, as illustrated in FIG. 1A, and stages 200-240, as illustrated in FIG. 2A.

As shown in FIG. 2B, the textual input 252 states: “a tiger is walking.” According to the text description, the asset to be generated is a tiger. A text-to-3D generator 254 is used to generate, based on at least part of the textual input 252, such as “a tiger [ . . . ],” 3D representations of the tiger, as shown in box 260. In this example, a mesh representation 262 and a 3DGS representation 264 are generated to represent a static tiger based on the textual input 252.

As indicated by arrow 270, a skeleton is embedded into the 3D representation of the tiger. For example, the skeleton is embedded into the mesh representation 262 of the tiger. A mapping is established between the optimizable variables for modeling the skeleton and the calculation of the 3DGS representation. In certain embodiments, the mapping is established through two stages. For example, at the skinning compute stage 266, the skeleton is mapped to the mesh 262, while at the skinning transfer stage 268, the skeleton is further mapped to the 3DGS representation 264 through the mesh 262. In certain embodiments, the transformation of the skeleton is linked to the deformation of the 3DGS representation 264 of the tiger through the deformation function expressed by Equation 3 and the warping function expressed by Equation 2.

Based on the embedded skeleton from the static 3D tiger representation, a sequence of static skeleton configurations corresponding to a plurality of time steps are produced. For example, stage 200 as shown in FIG. 2A can be performed to obtain the initial sequence of the skeleton configurations. To illustrate as an example, the sequence of skeleton configurations include skeleton configuration 272, skeleton configuration 274, and skeleton configuration 276, each corresponding to a time step.

As indicated by the arrows 278, the pipeline 250 can apply LBS to generate a sequence of 3DGS representation configurations, from which a sequence of 2D image frames for the tiger can be generated. For example, the pipeline 250 applies LBS to the skeleton configuration 272 to generate a corresponding 3DGS representation configuration, which is then rendered into an image frame 282 for the tiger. Similarly, the pipeline 250 generates an image frame 284 corresponding to the skeleton configuration 274 and an image frame 286 corresponding to the skeleton configuration 276.

The image frames 282, 284, and 286 form a video as input to a video DiT 290. The video DiT 290 also receive the textual input 252 as input to evaluate discrepancies between the input video and the textual input 252. The video DiT 290 generates a video SDS loss 292 based on the evaluation and backpropagates a gradient based on the loss (e.g., the video SDS loss 292 and/or other suitable losses) through the pipeline 250 to the skeletal space, as indicated by the dashed arrows 294.

The pipeline 250 updates the optimizable variables in the skeleton configurations based on the backpropagated gradient, thereby generating a sequence of updated skeleton configurations, such as the skeletons 272, 274, and 276 with new configurations. Similarly, the pipeline 250 generates an updated sequence of 3DGS representation configurations and then an updated sequence of image frames to form an updated input video. The video DiT 290 evaluates the updated input video in the context of the textual input 252 and then generates the loss gradient, which is backpropagated to the skeletal space to further update the skeleton configurations. This optimization process is performed for a number of iterations to eventually produce a synthesized motion of the tiger. The synthesized motion of the tiger can be represented in various forms, including a motion video of the skeleton, the 3DGS representation, 2D image frames, or other suitable format.

Referring back to FIG. 1A, at stage 130, with the synthesized motion from stage 120, the framework learns a physics-grounded simulation motion. In certain embodiments, the framework utilizes a physics-based simulator, such as an articulated rigid body simulator, to generate a physics-grounded simulation motion based on the synthesized motion of the skeleton.

In certain embodiments, the framework projects the distilled motion trajectory of the skeleton to the nearest solution achievable in physics-based tracking in a simulation environment. In at least one embodiment, the framework facilitates the transition from generation to simulation by optimizing a physical joint control sequence that minimizes the difference between the simulated and synthesized bone trajectories.

In certain embodiments, each bone is modeled as a rigid cuboid, with compound joints used to connect bones. This configuration aligns with the motion DoFs during motion distillation. In certain embodiments, a semi-implicit articulated rigid body simulator is used to simulate the skeleton under gravity and ground collision. The simulation process can be abstracted as a state transition function [symbol] :

$$[ {q}^{k + 1} , {\dot{q}}^{k + 1} ] = ( [ {q}^{k} , {\dot{q}}^{k} ] , Δ t , {τ}^{k} ) , \qquad ( Eq . 8 )$$

where q^{k} is the concatenation of the generalized coordinates of the bones at time step k, representing a 6-DoF rigid transformation, \dot{q}^{k} is the general velocity, Δt is the simulation time step size, and τ^{k} is active joint torques applied to the connected bones at joints. In certain embodiments, a Proportional-Derivative (PD) controller to provide active joint torques, where the torque at joint j around axis l is given by:

$${τ}^{k} {\vert}_{l} = {k}_{e} ( {\hat{θ}}_{jl} - {θ}_{jl} ) - {k}_{d} {\dot{θ}}_{jl} , \qquad ( Eq . 9 )$$

where \hat{θ}ⱼₗ is the control variable, \hat{θ}ⱼₗ is the current joint angle, kₑ and k_{d} are globally defined parameters. The formulation of Equation 9 tends to pull the joint angle θⱼₗ towards \hat{θ}ⱼₗ subject to damping. A motion-tracking loss can be calculated as:

$${ℒ}_{Crack} ( \hat{Θ} , {\dot{q}}^{0} ) = \frac{1}{F - 1} {\sum }_{i = 1}^{F - 1} {‖ {q}^{iN} - {\hat{q}}^{i} ‖}_{1} + {λ}_{3} M A E ( {Δ}_{t} \hat{Θ} ) , \qquad ( Eq . 10 )$$

where N is the ratio between the frame time of the target motion {\hat{q}ⁱ} and the simulation time step Δt, and \hat{Θ} is the concatenation of control variable per simulation step.

In certain embodiments, the initial generalized velocity (\dot{q}⁰) is optimized. The simulation starts from q⁰=Proj(\hat{q}⁰), where \hat{q}⁰ is vertically shifted such that the lowest bone touches the ground. In certain embodiments, N is in the hundreds for explicit simulators, resulting in thousands of simulation steps in total. This can cause severe gradient explosion issues during backpropagation. This issue can be alleviated by applying gradient clipping before each optimizer step. Additionally, a fine-grained gradient clipping strategy can be applied to further mitigate the gradient explosion issues, for example by applying gradient clipping every few tens of backward steps.

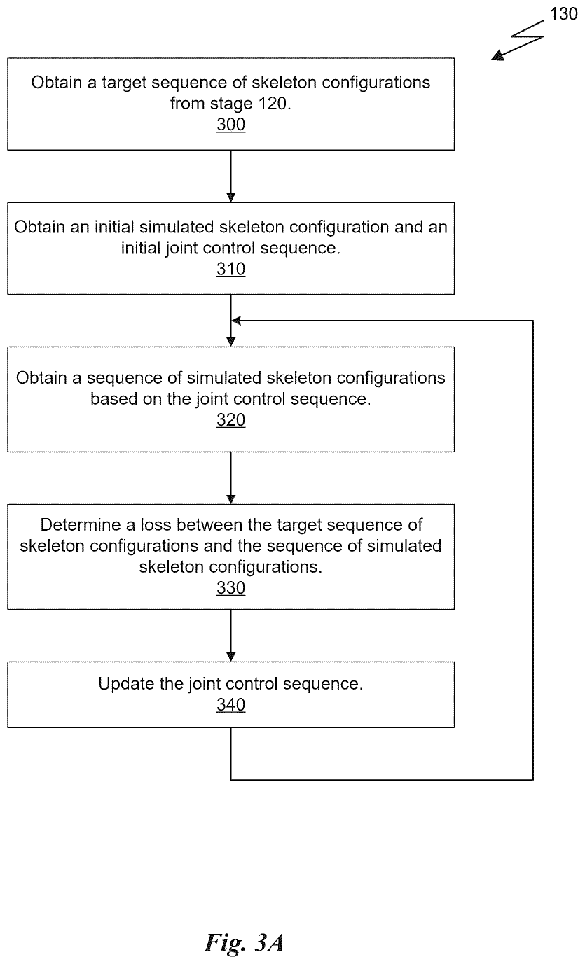

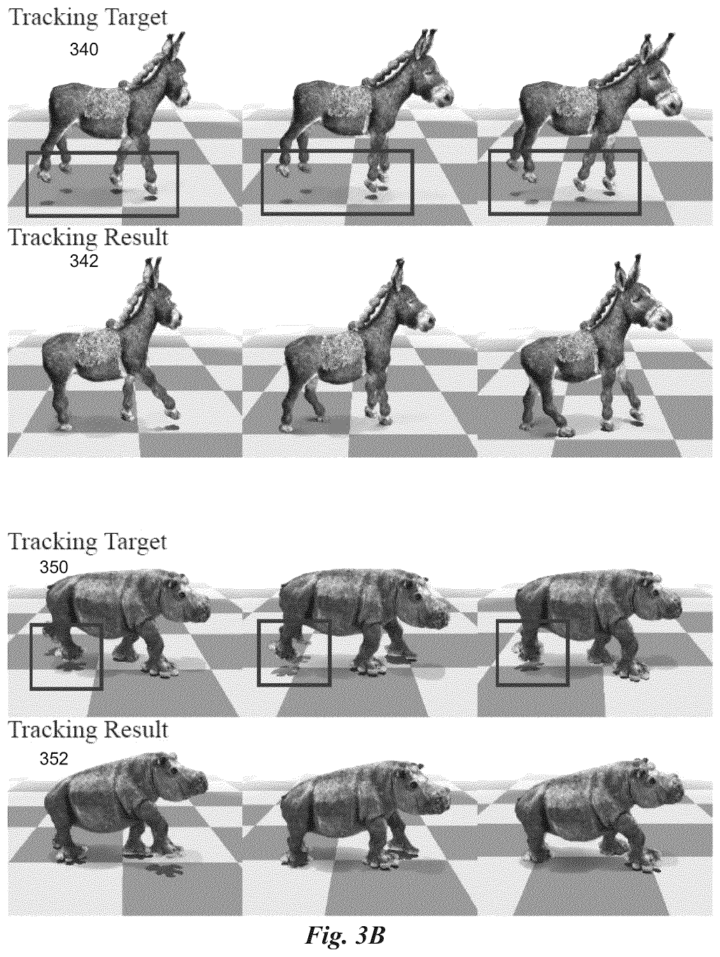

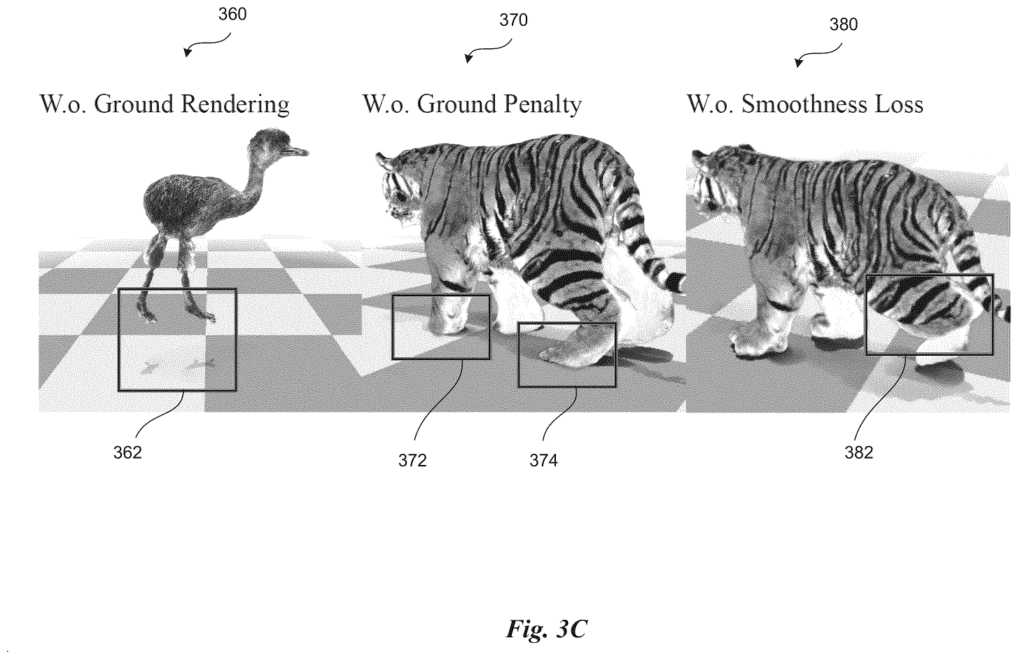

FIG. 3A is a flowchart illustrating a method for generating a simulated motion by executing stage 130 of the method 100, as shown in FIG. 1A, in accordance with some embodiments. Each block of the method, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, the method is described, by way of example, with respect to the test-driven generative framework. However, this method may additionally or alternatively be executed by any one framework/system, or any combination of frameworks/systems, including, but not limited to, those described herein. Furthermore, persons of ordinary skill in the art will understand that any framework/system that performs the method is within the scope and spirit of embodiments of the present disclosure.

At stage 300, the framework obtains a target sequence of skeleton configurations from stage 120 of the method 100 as illustrated in FIG. 1A. For example, the framework uses the synthesized skeletal motion from stage 120 as the target skeletal motion for the physics-based simulation. The synthesized skeletal motion includes a sequence of skeleton configurations, which serve as the target coordinates for the bones at each of a plurality of time steps.

At stage 310, the framework obtains an initial simulated skeleton configuration and an initial joint control sequence. The framework obtains an initial sequence of simulated skeleton configurations based on the initial simulated skeleton configuration and the initial joint control sequence. In certain embodiments, control variables in the simulation are initialized at this stage. For example, a control variable is associated with each joint for each axis during each transition between frames. The control variables provide a simulated motion sequence, which is referred to as the joint control sequence. In at least one embodiment, the simulation begins with a sequence of initial simulated skeleton configurations corresponding to a static motion and an initial joint control sequence includes control variables set to initial values. For example, the control variables may include, active joint torques (such as τ^{k} from Equations 8 and 9) applied to the connected bones at joints, representing active control signals. In at least one embodiment, the sequence of initial simulated skeleton configurations and the corresponding initial joint control sequence are derived based on an initial velocity.

During simulation, the joint control sequence is iteratively updated. At stage 320, the framework obtains the sequence of simulated skeleton configurations based on the joint control sequence at each iteration. During initialization, the initial sequence of simulated skeleton configurations can be generated based on the initial simulated skeleton configuration and the initial joint control sequence at this stage.

At stage 330, the framework determines a loss between the target sequence of skeleton configurations and the sequence of simulated skeleton configurations. For example, the motion track loss as expressed by Equation 10 can be calculated to determine the loss.

At stage 340, the framework updates the joint control sequence based on the loss.

Stages 320 through 340 are repeated to simulate the skeletal motion towards the target skeletal motion, utilizing the iteratively updated joint control sequence and the physics-grounded state transition function. The skeletal motion is simulated to align with the target coordinates of bones at each of the plurality of time steps produced by the motion synthesis stage (e.g., stage 120 as shown in FIG. 1A). The simulation involves iteratively optimizing the joint control sequence (e.g., through updating the control variables) by minimizing the difference between the synthesized skeletal motion and the simulated skeletal motion.

In certain embodiments, the joint control sequence and the physics-grounded state transition function are used to compute bone transformations under gravity and ground collision, for example using Equations 8 and 9. This process provides simulated coordinates of bones at each of the plurality of time steps. Then, a motion tracking loss ( [symbol] _{track}) is computed using Equation 10, which measures the difference—at each time step—between the simulated coordinates and the target coordinates. Finally, the gradients of the motion tracking loss is computed and used to update the control variables in the joint control sequence. Minimizing the motion tracking loss optimizes the control variables so that the motion produced by the control variables (corresponding to the simulated motion) matches the synthesized motion (e.g., generated based on the knowledge in the DiT prior).

In certain embodiments, stages 320 through 340 are repeated for a predetermined number of optimization iterations, such as 200 iterations.

FIG. 3B provides examples of the synthesized motion and the corresponding simulated motion, in accordance with some embodiments. To illustrate, the synthesized motion and the simulated motion are compared in the form of rendered 2D image frames. As shown in FIG. 3B, the synthesized motion from the stage 120 can serve as a tracking target 340, which may exhibit certain artifacts (as indicated by the boxes in the image frames). The simulated motion from the stage 130, indicated as the tracking result 342, is generated from the tracking target 340, which optimizes/refines the motion of the asset by incorporating physics grounds to the simulated motion. Similarly, the tracking target 350 may be produced from the stage 120, and used to generate the tracking result 352.

Finally, the framework outputs a simulated skeletal motion. The simulated skeletal motion consists of a sequence of simulated skeletal configurations

Referring back to FIG. 1A, at stage 140, the framework outputs a video of the moving 3D asset. In certain embodiments, the framework generates a sequence of 3DGS representation configurations for a plurality of time steps based on the simulated skeletal motion output from the stage 130, using the LBS interpolation scheme. In certain embodiments, the framework further renders a sequence of 2D image frames from the sequence of 3DGS representation configurations using a differentiable renderer, such as a differentiable Gaussian Splatting rasterizer. Then, a motion video is produced by combining the rendered image frames. However, it should be noted that other formats of the motion video can also be generated based on the simulated skeletal motion.

In certain embodiments, the loss function for SDS optimization, for example as performed at stage 120 of the method 100, can be formulated as:

$$ℒ = {ℒ}_{SDS} + {λ}_{1} {ℒ}_{smooth} + {λ}_{2} {ℒ}_{ground} , \qquad ( Eq . 11 )$$

where [symbol] _{SDS} is the SDS loss, [symbol] ₛₘₒₒₜₕ is a smoothness penalty, and [symbol] _{ground} is a ground penetration penalty. The smoothness penalty ( [symbol] ₛₘₒₒₜₕ) serves as a regularizer that can be applied over time to encourage time-consistent deformations. The ground penetration penalty ( [symbol] _{ground}) can be applied to enforce the assets to stay above the ground. In at least one embodiment, the smoothness penalty ( [symbol] ₛₘₒₒₜₕ) and/or the ground penetration penalty ( [symbol] _{ground}) are computed in the skeletal space. For example, the smoothness penalty ( [symbol] ₛₘₒₒₜₕ) and/or the ground penetration penalty ( [symbol] _{ground}) may be calculated based on the optimizable variables in the skeleton configurations, such as joint angles.

In certain embodiments, the framework can use the SDS loss ( [symbol] _{SDS}) alone to optimize the motion synthesis, for example over a certain number of iterations. Additionally and/or alternatively, the framework can use the loss calculated from Equation 8 to optimize the motion synthesis, where λ₁ and λ₂ are tunable parameters, ranging from 0 to 1.

Since the optimizable parameters in the optimization process (e.g., performed at stages 120 and/or 130) have physical meanings, smoothness can be directly enforced on the control parameters, which is defined as the mean absolute error (MAE) of the Laplacian of the control parameters with respect to time:

$${ℒ}_{smooth} = M A E ( {Δ}_{t} Θ ) , {( {Δ}_{t} Θ )}_{i} = {Θ}_{i - 1} - 2 {Θ}_{i} + {Θ}_{i + 1} . \qquad ( Eq . 12 )$$

The smoothness penalty helps ensure that changes in the parameters across consecutive frames are gradual. For example, incorporating the smoothness penalty can anneal the noisy nature of the SDS loss.

In certain embodiments, the ground penetration penalty, or the penetration loss, is defined as:

$${ℒ}_{ground} = \frac{1}{\vert V \vert} {\sum }_{υ ∈ V} max ( - , 0 ) , \qquad ( Eq . 13 )$$

where bones are conceptualized as a set of transformed cuboids, and V represents the set of vertices of these cuboids. The penetration loss penalizes any penetration of the asset below the ground plane by applying a penalty proportional to the depth below ground for each vertex.

In certain embodiments, the motion synthesis is performed for legged characters, including animals and humanoids, moving across the ground. In these examples, the asset's forward motion along x-axis is initialized by setting an initial displacement as [symbol] =νi for some constant velocity ν. The pace and trajectories of the assets can be further optimized during the distillation process.

FIG. 3C provides examples of artifacts, in accordance with some embodiments. Artifacts, as shown in boxes 362, 372, 374, and 382, can arise from the absence of ground rendering, as indicated by arrow 360; the absence of a ground penalty, as indicated by arrow 370; and the absence of a smoothness loss, as indicated by arrow 380. Without ground rendering, the synthesized motion appears above the ground because the video model lacks information about the ground's location. The absence of the ground penalty loss results in penetration into the ground. The smoothness loss can encourage time consistency across frames; without it, dramatic and unnatural deformations may occur in certain frames.

These artifacts can be addressed by the text-driven generative framework for articulated motion synthesis powered by large video diffusion models. Specifically, the framework offers an alternative to laborious motion authoring in traditional animation pipelines by distilling the motion knowledge from a video generation model. The low-DoF, skeleton-based parameterization of motion allows the distillation process to focus more on overall articulated motion patterns rather than local-scale shape deformations, resolving the common issue of shape inconsistency as in previous work on 4D generation, and thus results in improved physical plausibility of the generated motion. Furthermore, the generated skeletal motions can be transferred into simulation environments via physics-based motion tracking for further optimizing/refining the motion.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

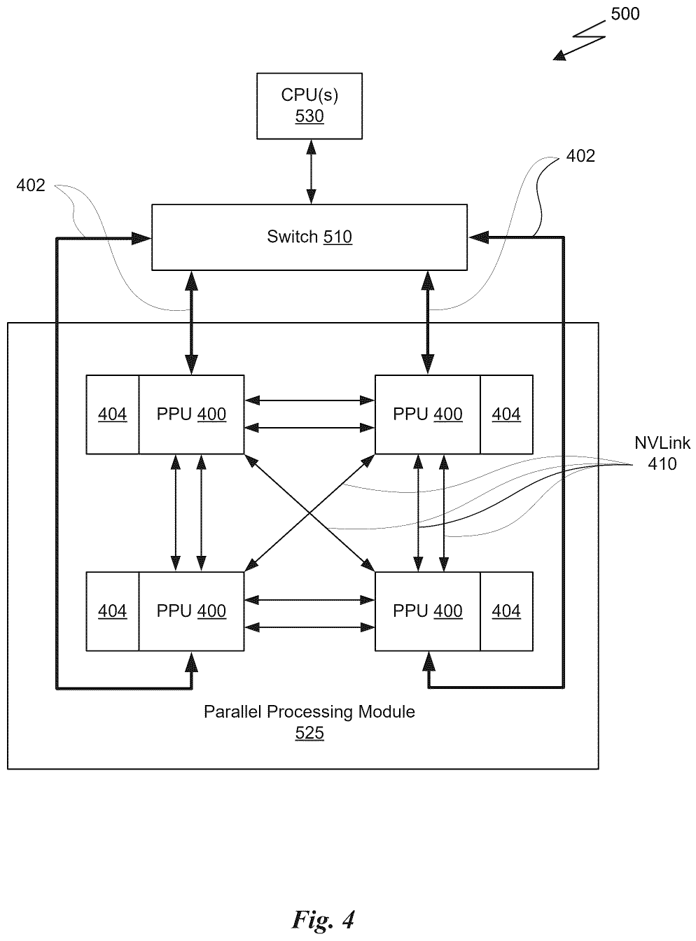

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

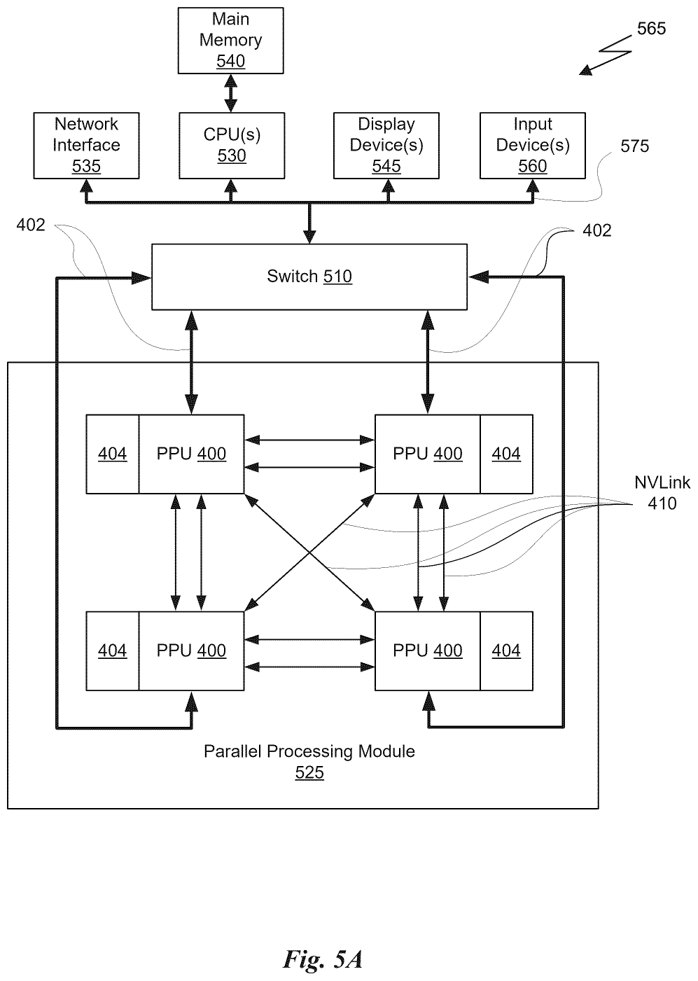

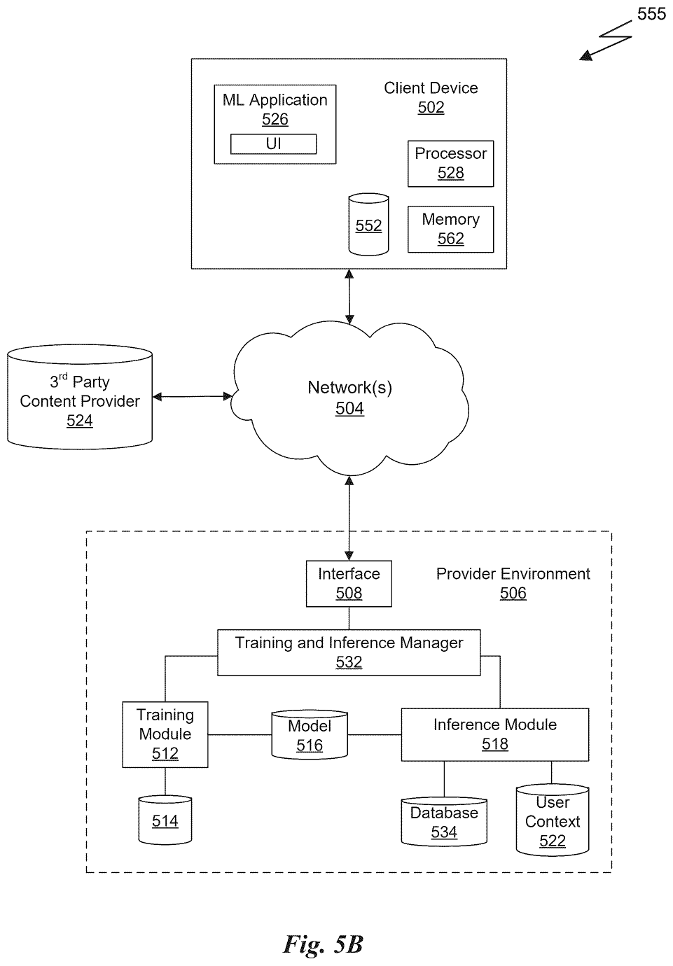

FIG. 5A illustrates an exemplary system 565 in which the various architecture and/or functionality of the various previous embodiments may be implemented. The exemplary system 565 may be configured to implement the method 100 shown in FIG. 1A.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

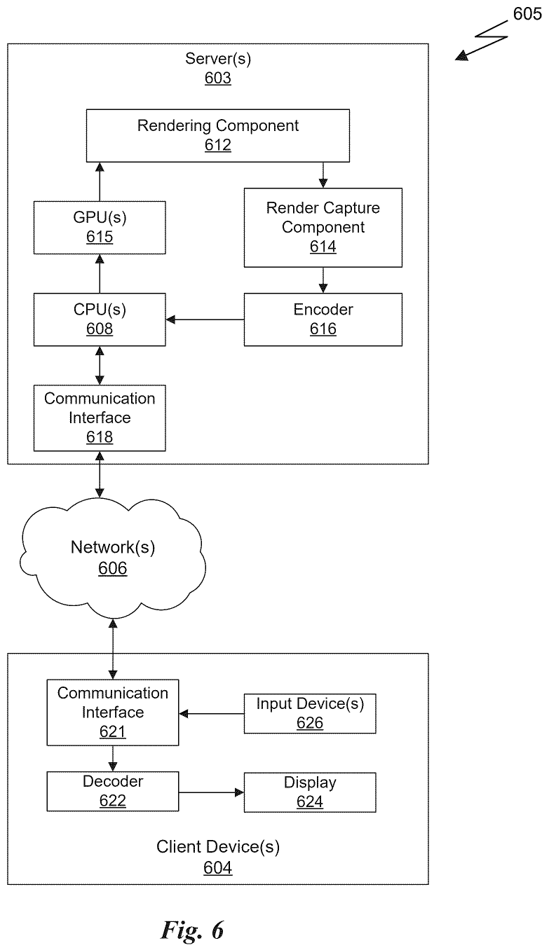

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for motion synthesis, comprising:
obtaining a static three-dimensional (3D) asset comprising a 3D spatial representation and an articulated skeleton embedded in the 3D spatial representation;
generating, based on the articulated skeleton, a sequence of skeleton configurations, each skeleton configuration corresponding to a time step of a plurality of time steps;
generating, for each skeleton configuration in the sequence of skeleton configurations, a corresponding 3D spatial representation configuration;
generating, based on the sequence of 3D spatial representation configurations, a sequence of image frames to provide a video;
obtaining, based on the video and a textual input describing a motion of the 3D asset, a video evaluation loss;
updating, based on the video evaluation loss, the sequence of skeleton configurations; and
outputting, based on the updated sequence of skeleton configurations, an updated video of motion of the 3D asset.

2. The computer-implemented method according to claim 1, further comprising:
obtaining a target sequence of skeleton configurations;
obtaining an initial simulated skeleton configuration and a joint control sequence that provides physics-grounded skeletal motion;
learning a simulated joint control sequence by updating parameters of the joint control sequence by iteratively reducing a difference between the target sequence of skeleton configurations and a sequence of simulated skeleton configurations;
outputting a final sequence of simulated skeleton configurations corresponding to the learned simulated joint control sequence; and
outputting, based on the final sequence of simulated skeleton configurations, a final video of simulated motion of the 3D asset.

3. The computer-implemented method according to claim 2, wherein learning the simulated joint control sequence is performed using a physics-grounded simulation incorporating gravity and ground collision.

4. The computer-implemented method according to claim 1, further comprising:
computing a video loss gradient based on the video evaluation loss; and
backpropagating the video loss gradient to the sequence of skeleton configurations.

5. The computer-implemented method according to claim 4, wherein the video loss gradient is computed in a latent space,
wherein the video loss gradient passes through a pixel space, a space corresponding to the 3D spatial representation, and a space corresponding to the articulated skeleton, and
wherein the video loss gradient is used to update the sequence of skeleton configurations in the space corresponding to the articulated skeleton.

6. The computer-implemented method according to claim 1, wherein the articulated skeleton comprises a set of bones and a set of joints that connect the set of bones, wherein motion of the articulated skeleton is modeled through a set of joint angles and bone transformations corresponding to the set of bones and the set of joints.

7. The computer-implemented method according to claim 6, wherein the bone transformations are obtained using Forward Kinematics based on the set of joint angles.

8. The computer-implemented method according to claim 6, wherein a video loss gradient, computed based on the video evaluation loss, is used to update the set of joint angles and the bone transformations to update the sequence of skeleton configurations in a space corresponding to the articulated skeleton.

9. The computer-implemented method according to claim 1, wherein the video is rendered with at least one of:
a non-uniform ground;
shadow casting; or
a varying camera trajectory.

10. The computer-implemented method according to claim 1, wherein the static 3D asset is obtained based on the textual input.

11. A system comprising:
one or more processors configured to:
obtain a static three-dimensional (3D) asset comprising a 3D spatial representation and an articulated skeleton embedded in the 3D spatial representation;
generate, based on the articulated skeleton, a sequence of skeleton configurations, each skeleton configuration corresponding to a time step of a plurality of time steps;
generate, for each skeleton configuration in the sequence of skeleton configurations, a corresponding 3D spatial representation configuration;
generate, based on the sequence of 3D spatial representation configurations, a sequence of image frames to provide a video;
obtain, based on the video and a textual input describing a motion of the 3D asset, a video evaluation loss;
update, based on the video evaluation loss, the sequence of skeleton configurations; and
output, based on the updated sequence of skeleton configurations, an updated video of motion of the 3D asset.

12. The system according to claim 11, wherein the one or more processors are further configured to:
obtain a target sequence of skeleton configurations;
obtain an initial simulated skeleton configuration and a joint control sequence that provides physics-grounded skeletal motion;
learn a simulated joint control sequence by updating parameters of the joint control sequence by iteratively reducing a difference between the target sequence of skeleton configurations and a sequence of simulated skeleton configurations;
output a final sequence of simulated skeleton configurations corresponding to the learned simulated joint control sequence; and
output, based on the final sequence of simulated skeleton configurations, a final video of simulated motion of the 3D asset.

13. The system according to claim 12, wherein learning the simulated joint control sequence is performed using a physics-grounded simulation incorporating gravity and ground collision.

14. The system according to claim 11, wherein the one or more processors are further configured to:
compute a video loss gradient based on the video evaluation loss; and
backpropagate the video loss gradient to the sequence of skeleton configurations.

15. The system according to claim 14, wherein the video loss gradient is computed in a latent space,
wherein the video loss gradient passes through a pixel space, a space corresponding to the 3D spatial representation, and a space corresponding to the articulated skeleton, and
wherein the video loss gradient is used to update the sequence of skeleton configurations in the space corresponding to the articulated skeleton.

16. The system according to claim 11, wherein the articulated skeleton comprises a set of bones and a set of joints that connect the set of bones, wherein motion of the articulated skeleton is modeled through a set of joint angles and bone transformations corresponding to the set of bones and the set of joints.

17. The system according to claim 16, wherein the bone transformations are obtained using Forward Kinematics based on the set of joint angles.

18. The system according to claim 16, wherein a video loss gradient, computed based on the video evaluation loss, is used to update the set of joint angles and the bone transformations to update the sequence of skeleton configurations in a space corresponding to the articulated skeleton.

19. The system according to claim 11, wherein the video is rendered with at least one of:
a non-uniform ground;
shadow casting; or
a varying camera trajectory.

20. The system according to claim 11, wherein the static 3D asset is obtained based on the textual input.

21. A non-transitory machine-readable medium having stored thereon a set of instructions, which if performed by one or more processors, cause the one or more processors to:
obtain a static three-dimensional (3D) asset comprising a 3D spatial representation and an articulated skeleton embedded in the 3D spatial representation;
generate, based on the articulated skeleton, a sequence of skeleton configurations, each skeleton configuration corresponding to a time step of a plurality of time steps;
generate, for each skeleton configuration in the sequence of skeleton configurations, a corresponding 3D spatial representation configuration;
generate, based on the sequence of 3D spatial representation configurations, a sequence of image frames to provide a video;
obtain, based on the video and a textual input describing a motion of the 3D asset, a video evaluation loss;
update, based on the video evaluation loss, the sequence of skeleton configurations; and
output, based on the updated sequence of the skeleton configurations, an updated video of motion of the 3D asset.

22. The non-transitory machine-readable medium according to claim 21, wherein the one or more processors are further configured to:
obtain a target sequence of skeleton configurations;
obtain an initial simulated skeleton configuration and a joint control sequence that provides physics-grounded skeletal motion;
learn a simulated joint control sequence by updating parameters of the joint control sequence by iteratively reducing a difference between the target sequence of skeleton configurations and a sequence of simulated skeleton configurations;
output a final sequence of simulated skeleton configurations corresponding to the learned simulated joint control sequence; and
output, based on the final sequence of simulated skeleton configurations, a final video of simulated motion of the 3D asset.
